(19) United States
(12) Patent Application Publication
(10) Pub. No.: US 2021/0036410 A1
(43) Pub. Date: Feb. 4, 2021

(54) ANTENNA INSTALLATION CONFIGURATION

(71) Applicant: DENSO TEN Limited, Kobe-shi (JP)

(72) Inventors: Hideyuki FUJII, Kobe-shi (JP); Shoji HOSOMI, Kobe-shi (JP)

(73) Assignee: DENSO TEN Limited, Kobe-shi (JP)

(21) Appl. No.: 16/835,548

(22) Filed: Mar. 31, 2020

(30) Foreign Application Priority Data
Jul. 29, 2019 (JP) 2019-138767

(51) Int. Cl. H01Q 1/32; B60R 11/02; G01C 21/36; H01Q 1/24; H04B 1/3822

(52) U.S. Cl. CPC H01Q 1/3208; B60R 11/02; B60R 2011/0005; H01Q 1/24; H04B 1/3822; G01C 21/36

(57) ABSTRACT

An antenna installation configuration includes: a vehicle-mounted apparatus that is mounted to a dashboard of a vehicle, the vehicle-mounted apparatus including a human-machine interface and a main body that is arranged in front of the human-machine interface, relative to a traveling direction of the vehicle; and an antenna attached to the main body, the antenna having a directivity directed toward an inside of a cabin of the vehicle and bypassing the human-machine interface.

### BACKGROUND OF THE INVENTION

### Field of the Invention

The invention relates to an installation configuration of an antenna that is attached to a vehicle-mounted apparatus that is mounted to a dashboard of a vehicle.

### Description of the Background Art

Conventionally, various vehicle-mounted apparatuses, devices, and units capable of communication with a wireless communication device in a cabin of a vehicle have been developed. For example, a conventional vehicle-mounted apparatus (e.g., a car navigation apparatus) is configured to include a communication apparatus including an antenna having a directivity directed toward an inside of the cabin of the vehicle so as to ensure good quality of the communication with the wireless communication device in the cabin of the vehicle.

Meanwhile, there exists a vehicle-mounted apparatus including a human-machine interface (e.g. a display for supplying information to a user, an operation device for receiving a user operation, etc.) and a main body that is arranged in front (side in a traveling direction of the vehicle) of the human-machine interface. When an antenna is attached to the human-machine interface of the vehicle-mounted apparatus having such a configuration, the vehicle-mounted apparatus utilizes a conventional technology so as to have no problem with communication quality with the wireless communication device in the cabin.

However, there is a case in which an antenna is attached to the main body of the vehicle-mounted apparatus due to a variety of constraints. In this case, since the human-machine interface is located between the antenna and the wireless communication device in the cabin, even if the conventional technology is applied, there is a possibility of poor quality in communication between the vehicle-mounted apparatus and the wireless communication device in the cabin because radio waves are blocked by the human-machine interface.

### SUMMARY OF THE INVENTION

According to one aspect of the invention, an antenna installation configuration includes: a vehicle-mounted apparatus that is mounted to a dashboard of a vehicle, the vehicle-mounted apparatus including a human-machine interface and a main body that is arranged in front of the human-machine interface, relative to a traveling direction of the vehicle; and an antenna attached to the main body, the antenna having a directivity directed toward an inside of a cabin of the vehicle and bypassing the human-machine interface.

An object of the invention is good quality of communication between a vehicle-mounted device and a wireless communication device in a cabin of a vehicle when an antenna is attached to a vehicle-mounted device that includes a human-machine interface and a main body that is arranged in front of the human-machine interface, in a traveling direction of the vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an inside of a cabin of a vehicle including a vehicle-mounted device of an embodiment of the invention;

FIG. 2 is a side view of the vehicle-mounted device of the embodiment;

FIG. 3 is a perspective view of a main body included in the vehicle-mounted device of the embodiment;

FIG. 4 is a perspective view of an antenna;

FIG. 5 is a side view of a vehicle-mounted device of a first modification;

FIG. 6 is a side view of a vehicle-mounted device of a second modification;

FIG. 7 is a perspective view of a main body included in the vehicle-mounted device of the second modification;

FIG. 8 is a side view of a vehicle-mounted device of a third modification;

FIG. 9 is a perspective view of a main body included in the vehicle-mounted device of the third modification;

FIG. 10 is a side view of a vehicle-mounted device of a fourth modification;

FIG. 11 is a perspective view of a main body included in the vehicle-mounted device of the fourth modification;

FIG. 12 is a side view of a vehicle-mounted device of a fifth modification;

FIG. 13 is a side view of a vehicle-mounted device of a sixth modification;

FIG. 14 is a side view of a vehicle-mounted device of a seventh modification; and

FIG. 15 is a side view of a vehicle-mounted device of an eighth modification;

### DESCRIPTION OF THE EMBODIMENTS

With reference to the drawings, an embodiment of the invention, as an example, will be described below.

<1. Embodiment>

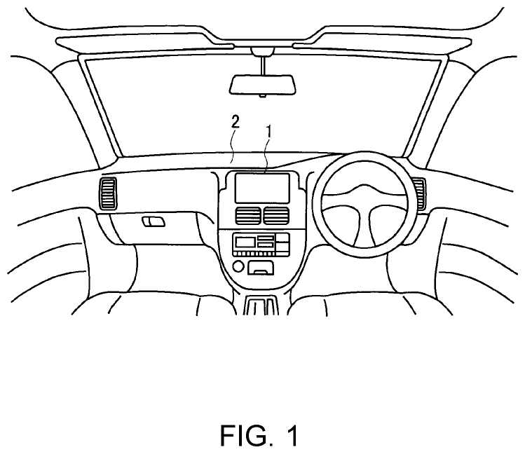

A vehicle-mounted device 1 of this embodiment of the invention (hereinafter referred to simply as “vehicle-mounted device 1”) includes, for example, a navigation function, an audio function, a communication function for near field communication (e.g. Bluetooth (registered trademark) communication) with a wireless communication device in a cabin of a vehicle. As shown in FIG. 1, the vehicle-mounted device 1 is mounted to a dashboard 2 provided in the cabin of the vehicle.

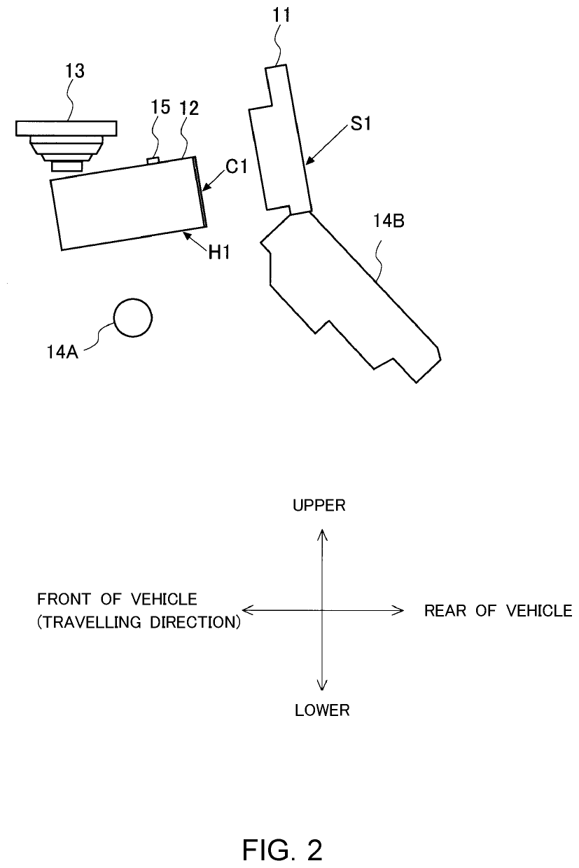

As shown in FIG. 2, the vehicle-mounted device 1 of the embodiment includes a display 11, an example of a human-machine interface, and a main body 12 that is arranged in front (side in a traveling direction of the vehicle) of the display 11. The display 11 may be configured to include an operation portion, such as a touch panel switch and a hard switch, so as to receive a user operation.

The display 11 is mounted to the dashboard 2 between a driver seat and a passenger seat, having a display screen S1 to be seen (refer to FIGS. 1 and 2). For example, a heater control panel 14B is provided below the display 11. The entire main body 12 is located inside the dashboard 2. The main body 12 is attached to the vehicle via a bracket (not illustrated).

The display 11, the main body 12 and a loudspeaker 13 are connected to a relay (not illustrated) in the vehicle via a wire. Thus, for example, an image signal is sent from the main body 12 to the display 11 via the relay, and an operation signal is sent from the display 11 to the main body 12 via the relay. A sound signal is sent from the main body 12 to the loudspeaker 13 via the relay.

In addition to the display 11, the main body 12, and the loudspeaker 13, a reinforcement 14A, a framework member of the vehicle, is located inside the dashboard 2. The reinforcement 14A is arranged, for example, below the display 11 and the main body 12, and in front of the display 11.

The main body 12 includes a case H1 and a cover C1 that covers an opening of the case H1. The case H1 and the cover C1 are metal parts and formed, for example, by sheet metal processing.

The main body 12 further includes an electronic part, an electronic unit and/or an electronic device for executing functions of the vehicle-mounted device 1. The part, unit, and/or device is arranged in the case H1. For example, a communication module is arranged in the case H1. The communication module is a modularized electronic part to execute the communication function for the near field communication with the wireless communication device in the cabin.

An antenna 15 is attached to the main body 12 so as to have a directivity of the antenna directed toward an inside of the cabin of the vehicle and to bypass the display 11. Thus, since interruption of the communication by the display 11 can be prevented between the vehicle-mounted device 1 and the wireless communication device in the cabin, the communication quality can be good between the vehicle-mounted device 1 and the wireless communication device in the cabin. Further, since the antenna 15 is attached to the main body 12, a wire connecting the antenna 15 with the communication module can be shorter as compared to a configuration in which the antenna 15 is attached to the display 11.

In this embodiment, the directivity of the antenna 15 is directed toward a ceiling board of the cabin of the vehicle. The ceiling board of the cabin is a metal sheet. Thus, by utilizing reflection of the radio waves from the ceiling board of the cabin, the communication quality can be good between the vehicle-mounted device 1 and the wireless communication device in the cabin. Being different from this embodiment, the directivity of the antenna 15 may not be directed toward the ceiling board of the cabin.

In this embodiment, the antenna 15 is attached to a top outer surface of the case H1. In this case, a position for attaching the antenna 15 can be selected from a broad area on the top outer surface. Thus, a design choice for the position for attaching the antenna 15 can be wide.

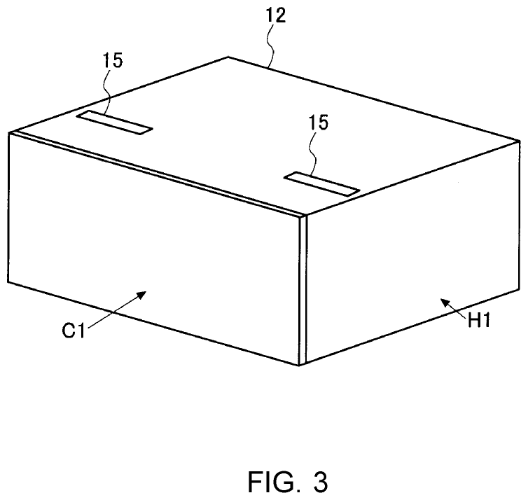

As shown in FIG. 3, a number of the antennas 15 is two in this embodiment. Being different from this embodiment, the number of the antenna 15 may be one or three or more. Further, when a plurality of the antennas 15 are attached, directivities of those antennas 15 may be same or different from one another.

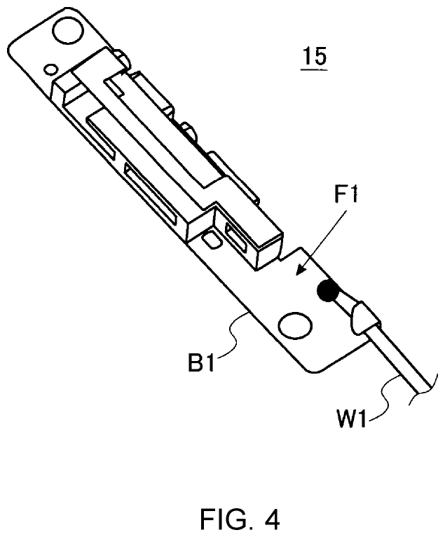

In this embodiment, as shown in FIG. 4, the antenna 15 is a sheet metal antenna. An end of a wiring code W1 connecting the antenna 15 with the communication module is soldered on a first surface F1 of a base board B1 of the antenna 15. The wiring code connecting the antenna 15 with the communication module is covered and insulated, except both ends of the wiring code. In this embodiment, the base board B1 of the antenna 15 is attached to the top outer surface of the case H1 and is fixed to the top outer surface of the case H1 with a screw and the like.

<2. Modifications>

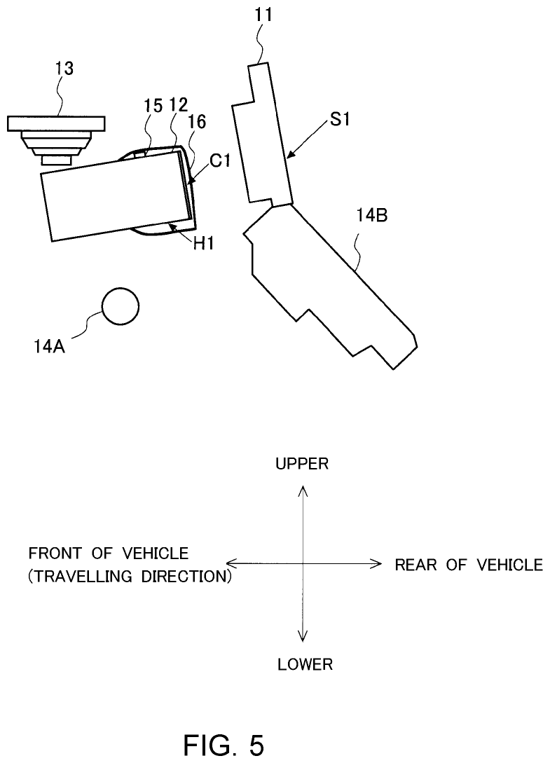

In order to prevent a breakage of an antenna 15 caused by a contact to the antenna 15 of a worker who attaches or removes a vehicle-mounted device 1 in a cabin, as shown in a first modification shown in FIG. 5, it is recommended that a resin protective cover 16 should be provided to a main body 12 to cover the antenna 15.

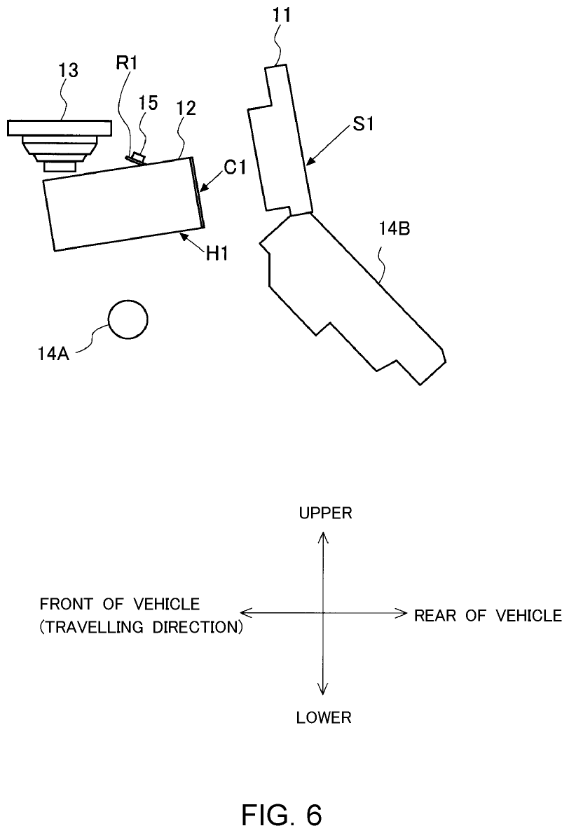

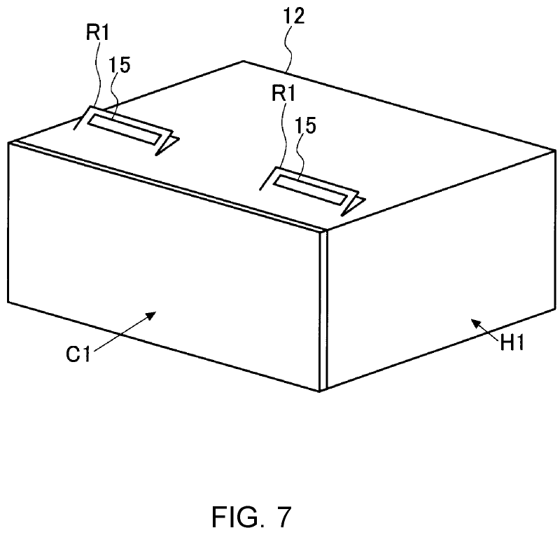

As shown in a second modification shown in FIGS. 6 and 7, an antenna 15 may be attached to a projection R1 that is formed of a cut-out portion of a top surface of a case H1 and is bent outward relative to the case H1. In this configuration, an angle of the projection R1 relative to the top surface of the case H1 can be adjusted. Accordingly, a direction of a directivity of the antenna 15 can be easily adjusted. Further, since the projection R1 is turned up outward, not inward, there is no possibility that the projection R1 contacts an electronic device in the case H1.

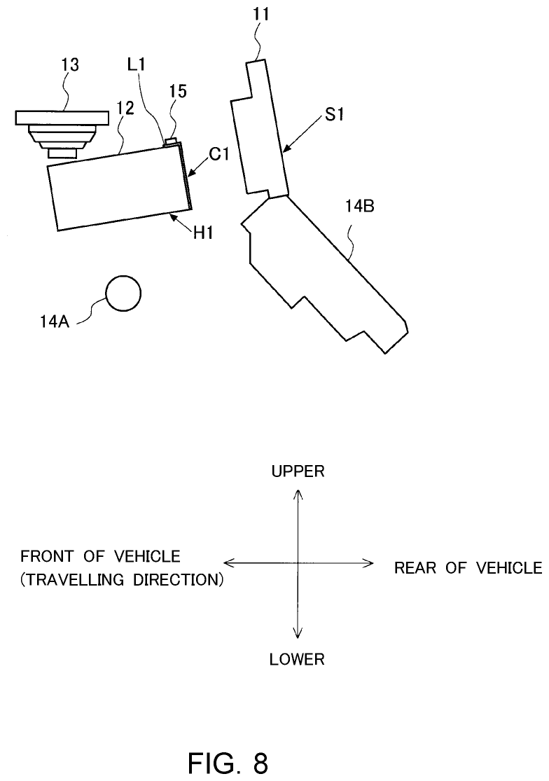

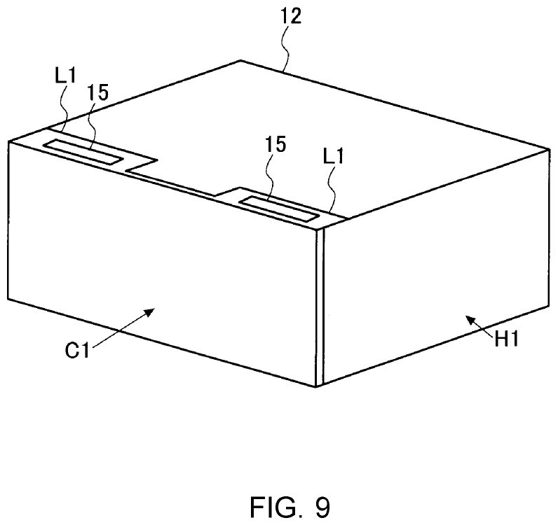

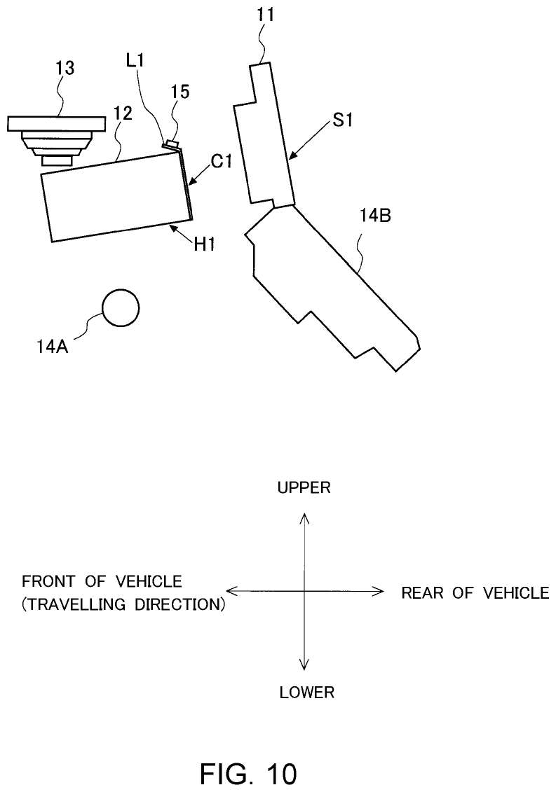

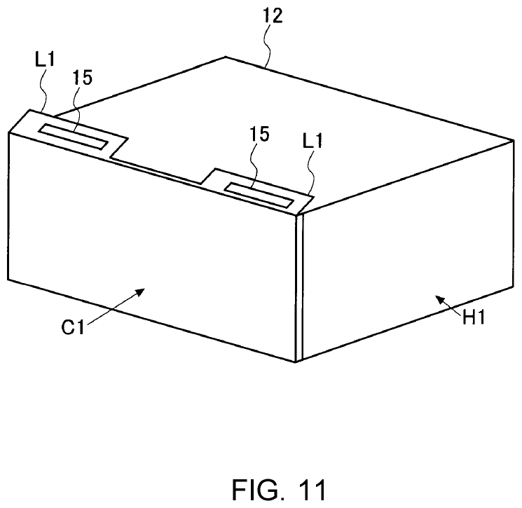

As shown in a third modification shown in FIGS. 8 and 9 and a fourth modification shown in FIGS. 10 and 11, an antenna 15 may be attached to a connection portion L1 that is connected to a cover C1 and is bent from the cover C1. In this configuration, since an angle of the connection portion L1 relative to the cover C1 can be adjusted, a direction of a directivity of the antenna 15 can be easily adjusted. Further, there is no possibility that a shielding performance of the case H1 is affected.

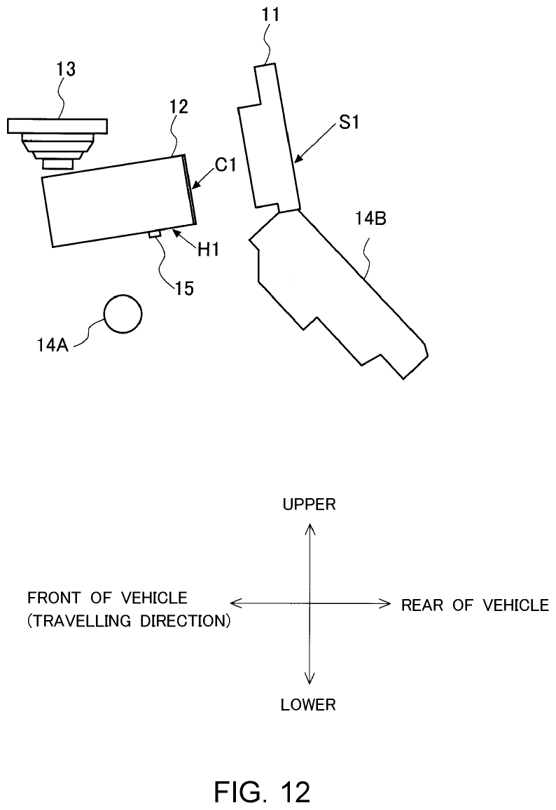

Further, in the foregoing embodiment, the antenna 15 is attached to the top outer surface of the case H1. However, as shown in a fifth modification shown in FIG. 12, an antenna 15 may be attached to a bottom outer surface of a case H1.

In the fifth modification, a directivity of the antenna 15 is directed toward a floorboard of a cabin of a vehicle. The floorboard of the cabin is a metal sheet. Thus, by utilizing reflection of radio waves from the floorboard of the cabin, communication quality can be good between a vehicle-mounted device 1 and a wireless communication device in the cabin. Being different from the fifth modification, the directivity of the antenna 15 may not be directed toward the floorboard of the cabin.

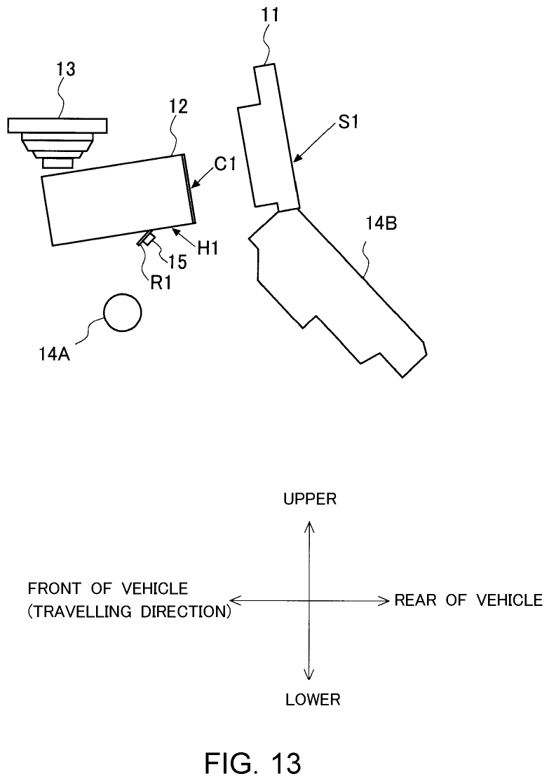

In the foregoing second modification, the projection R1 is formed of the cut-out portion of the top surface of the case H1 and is bent outward relative to the case H1. However as shown in a sixth modification shown in FIG. 13, a projection R1 may be formed of a cut-out portion of a bottom surface of a case H1 and is bent outward relative to the case H1.

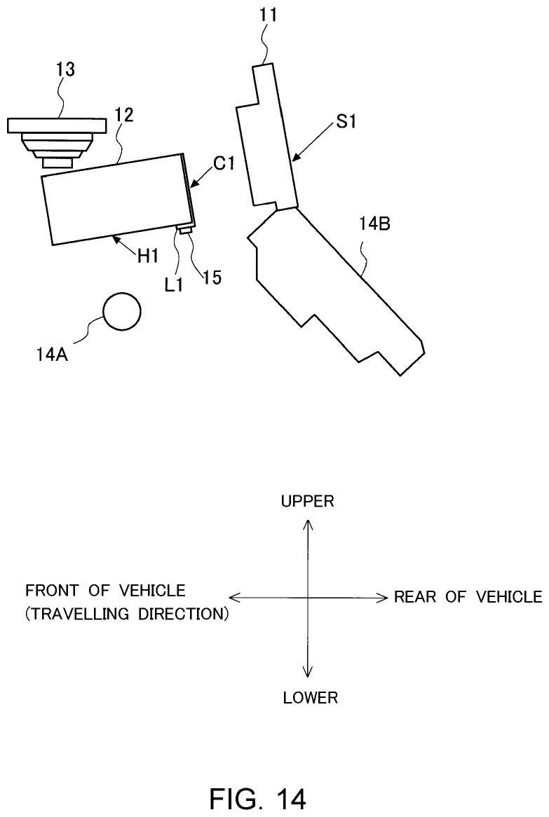

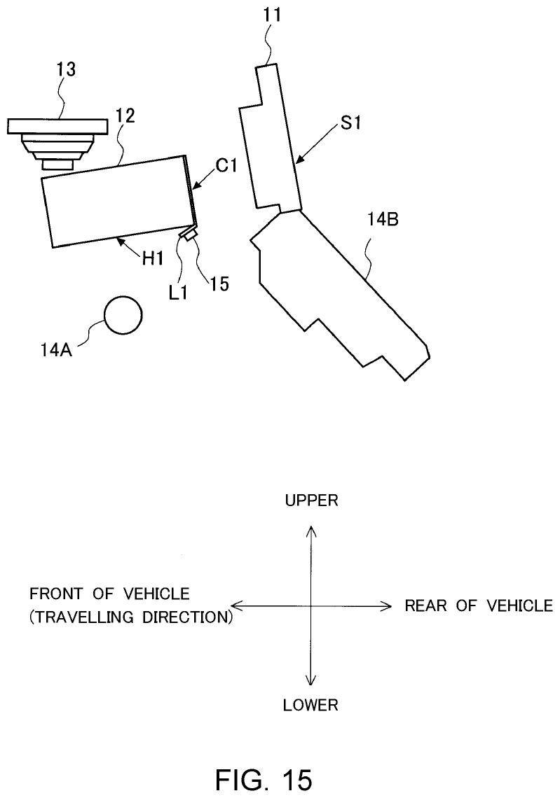

In the foregoing third and fourth modifications, the connection portion L1 is provided so as to cover an end portion of a top surface of the case H1 on a rear side (a side opposite to a traveling direction of the vehicle). However, as shown in a seventh modification shown in FIG. 14 and an eighth modification shown in FIG. 15, a connection portion L1 may be provided to cover an end portion of a bottom surface of the case H1 on the rear side.

<3. Notes>

The configurations and the elements of the embodiment and the modifications in this description are only examples. The configurations and the elements of the embodiment and modifications may be changed properly without departing a scope of a technical idea of the invention. Moreover, the embodiment and the modifications may be combined with one another in a possible range.

For example, an antenna 15 is attached to a left outer surface or a right outer surface of a case H1.

Further, for example, an antenna 15 may be attached to a top outer surface of a case H1 and another antenna 15 may be attached to a bottom outer surface of the case H1.

Further, for example, when a member, a device, a unit, or an apparatus other than human-machine interface exists in the rear of a main body 12, and the member, the device, the unit, or the apparatus includes a metal part having a relatively large surface, it is recommended that an antenna 15 should be attached to a main body 12 so as to have a directivity directed toward a direction in which electronic waves bypass the member, the device, the unit, or the apparatus including the metal part having the relatively large surface. Some among the member, the device, the unit, and the apparatus including the metal part having the relatively large surface are a heater control panel 14B and a loudspeaker including a speaker grille that is arranged in front of a sound output part of the loudspeaker.

While the invention has been shown and described in detail, the foregoing description is in all aspects illustrative and not restrictive. It is therefore understood that numerous other modifications and variations can be devised without departing from the scope of the invention.

What is claimed is:

1. An antenna installation configuration comprising:
a vehicle-mounted apparatus that is mounted to a dashboard of a vehicle, the vehicle-mounted apparatus including a human-machine interface and a main body that is arranged in front of the human-machine interface, relative to a traveling direction of the vehicle; and
an antenna attached to the main body, the antenna having a directivity directed toward an inside of a cabin of the vehicle and bypassing the human-machine interface.

2. The antenna installation configuration according to claim 1, wherein
the antenna is attached to the main body to have the directivity directed toward a ceiling board or a floorboard of the cabin of the vehicle.

3. The antenna installation configuration according to claim 1, wherein
the main body includes a case, and
the antenna is attached to a top outer surface, a bottom outer surface, a left outer surface, or a right outer surface of the case.

4. The antenna installation configuration according to claim 3, wherein
the antenna is attached to a projection that is formed of a cut-out portion of a top surface, a bottom surface, a left surface, or a right surface of the case, the cut-out portion being bent outward relative to the case.

5. The antenna installation configuration according to claim 1, wherein
the main body includes a case, a cover that covers an opening of the case, and a connection portion connected to the cover and bent from the cover, and the antenna is attached to the connection portion.

6. The antenna installation configuration according to claim 1, wherein
the main body includes a nonconductive member covering the antenna.

7. The antenna installation configuration according to claim 1, wherein
the directivity of the antenna is above, below, to a left-side or to a right side of the human-machine interface.

8. The antenna installation configuration according to claim 1, wherein
the human-machine interface includes a touchscreen.
